(19) United States
(12) Patent Application Publication
(10) Pub. No.: US 2022/0044255 A1
(43) Pub. Date: Feb. 10, 2022

(54) RISK MITIGATION FOR SERVICE DELIVERY

(71) Applicant: Dell Products L.P., Round Rock, TX (US)

(72) Inventors: Rui Leca, Cork (IE); James O'Mahony, Cork (IE); John Finn, Mitchelstown (IE); Fiona Munchberg, Cork (IE); Denis Gerald Noonan, Mallow (IE); Brian Power, Cork (IE); Bridget Drexler, Bray (IE); Martin Kerrigan, Ballinora (IE); Derek OKeeffe, Cork (IE); Waqas Raja, Cork (IE)

(73) Assignee: Dell Products L.P., Round Rock, TX (US)

(21) Appl. No.: 16/984,647

(22) Filed: Aug. 4, 2020

(51) Int. Cl. G06Q 30/00

(52) U.S. Cl. CPC G06Q 30/0185

(57) ABSTRACT

A system and method mitigate configuration change risk for a managed service in a customer environment. Reconfiguration commands sent to a management interface are intercepted and provided to a mitigation service executing in the customer environment. The mitigation service computes a risk rating for each such command based on a wide variety of factors. If the risk is low, then the mitigation service passes the command transparently to the management interface for execution. However, if the risk is too high, then the mitigation service requests an authorization code before the command can be executed. The acceptable level of risk may be set jointly by the customer and the managed service provider according to a service level agreement. Authorization codes can confirm performance of many mitigation actions, including approval by the customer or a supervising manager, studying relevant documentation, and clean execution of the command in a testing environment.

### FIELD

The disclosure pertains generally to service management, and more particularly to mitigating risks when implementing change within a customer environment.

### BACKGROUND

Many businesses outsource management of their information technology and information services to managed service providers (MSPs) for a variety of reasons, including to allow them to focus on their core competencies and to cut costs. MSPs work with their customers to learn their business information problems, and to solve them. Typical problems include, among others: user authentication; hardware and software systems management; data storage, warehousing, backup, and recovery; and computer network installation, monitoring, and security. The solutions generally require the MSP to deploy and maintain, and very often develop and create, managed services. A managed service is a specific style of service that is developed to suit to the needs of each business, aligned to a Statement of Work, which outlines the provision of that service delivery to the customer. The delivery of this service can be measured according to pre-agreed performance metrics, typically set forth in a service-level agreement (SLA) between the business and the MSP.

Because the MSP is bound by the SLA, implementing a software or hardware change in a customer environment carries the potential for significant legal and customer relationship risks. For example, software engineers employed by the MSP may serve multiple customers and may become confused when switching between different customer configurations. This is especially true if an MSP engineer has different levels of familiarity with different customers and their operating environment and service configurations. The details of the problem presented by the customer often makes a solution look much easier than it is to design or implement. As MSP engineers have different levels of experience, some make take on problems that are better served by other members of their team. Service delivery is made more difficult and error-prone when making changes in the operational environment of an outside party (i.e., a customer), as opposed to making changes in one's own information technology infrastructure. More worryingly, failure to satisfy an SLA can have a profound negative impact on the trust that customers and potential customers have in the MSP.

### SUMMARY OF DISCLOSED EMBODIMENTS

Disclosed embodiments mitigate configuration change risk for a managed service in a customer environment. Reconfiguration commands sent to a management interface are intercepted and provided to a mitigation service executing in the customer environment. The mitigation service computes a risk rating for each such command based on a wide variety of factors. If the risk is low, then the mitigation service passes the command transparently to the management interface for execution. However, if the risk is too high, then the mitigation service requests an authorization code before the command can be executed. The acceptable level of risk may be set jointly by the customer and the managed service provider according to a service level agreement. Different authorization codes can confirm performance of different mitigation actions, including approval by the customer or a supervising manager, studying relevant documentation, and clean execution of the command in a testing environment.

Embodiments provide several technical advantages over the prior art. A configurable risk rating may be used to assess various risks of data center configurations before they are implemented. A risk rating can be computed at different granularities or levels, i.e. determining a global risk rating, or a risk rating specific to each customer, or even a risk rating specific to use of each deployment variable, software application, or hardware component. Risk ratings can be applied against individual components of a configuration change and combined to form an overall risk rating for the change. Thus, a risk rating for a particular disk type that is known to be troublesome, may be combined with a risk rating for the implementing MSP engineer who has not installed that disk type before into a customer environment, to compute an overall risk rating that suggests or requires a mitigation action to be taken. Risk ratings may be further based on a global database of known configuration changes that cause issues, and other business information.

Risk ratings have been developed with a whole-system perspective. Risk ratings for a given command may thus account for risks relating to not only the device or service associated with the command, but also to dependent or related devices and services. For example, if the managed service provider needs to add storage to a disk array, the risk rating can measure risks relating to a data backup device and service that might also need to be reconfigured.

Another technical advantage is that control over risk mitigation can be shared by multiple groups within the managed service provider and its customers. For example, a customer could implement a moratorium on decommissioning a particular service for a duration determined by the customer. Customers can have different risk ratings for different configurations. For example, a customer may have a risk-averse production configuration but a risk-tolerant staging configuration.

Moreover, embodiments can force an MSP configuration engineer to take particular actions to proceed with reconfiguration. One such action may be confirming that the person has studied related issues and documentation. Another such action may be confirming that another MSP engineer, or a supervisor, or the customer approves of the reconfiguration. Still another action may be confirming that the person has already tested the reconfiguration in a sandbox or other non-customer environment.

Another advantage is a reduced likelihood of configuration errors, such as data loss when performing services on customer equipment, benefiting both the customer and the MSP. Another is enabling more junior MSP staff to do more work, allowing the MSP to improve its profit margins and improve employee satisfaction by giving employees greater access to customer systems while retaining a safety net against errors. And embodiments could themselves be sold to customers as a separate service, advantageously increasing MSP revenue.

Thus, a first embodiment is a system for mitigating configuration change risk for a managed service in a customer environment. The system includes a command interceptor configured for intercepting a command sent to a management interface for altering operation of a managed service. The system also includes a risk rating module configured for rating a risk of error if the intercepted command were to be executed in the customer environment. The system further includes a thresholding module configured for comparing the rated risk of error to a given error threshold. The system moreover includes a command forwarder configured for, when the rated risk of error is below the given error threshold, forwarding the intercepted command to the management interface to execute the command, thereby altering the operation of the managed service. Finally, the system includes an authorization module configured for, when the rated risk of error is equal to or above the given error threshold, (1) requesting an authorization code, and (2) only in response to receiving the authorization code, forwarding the intercepted command to the management interface to execute the command, thereby altering the operation of the managed service.

In some embodiments, the management interface comprises a command line interface (CLI) and the command interceptor includes a wrapper around the CLI.

In some embodiments, the management interface comprises an application programming interface (API) and the command interceptor includes a proxy.

In some embodiments, the risk rating module is configured for combining risk factors relating to a respective plurality of sources of risk.

Some embodiments further have a knowledge database that is executing outside the customer environment, and the risk rating module is configured for obtaining the risk factors from the knowledge database.

In some embodiments, risk rating module is configured for multiplying risk factors associated with: the customer environment, or the customer, or the intercepted command, or a person who sent the intercepted command, or any managed software or hardware associated with the intercepted command, or the vendor of any such managed software or hardware, or errors logged by the managed service, or any combination of these.

In some embodiments, the risk factors are provided as default values that are increased or decreased on a per-customer basis.

In some embodiments, the given error threshold is provided as a default value that is increased or decreased on a per-customer basis.

In some embodiments, the authorization module is configured for requesting an authorization code that indicates completion, by a person who sent the intercepted command to the management interface, of a particular risk-mitigating action from a plurality of such actions.

In some embodiments, the plurality of risk-mitigating actions includes confirming: that an administrative supervisor or peer of the person has approved execution of the intercepted command, or that the person has read a training document relating to the intercepted command, or that the person has executed the intercepted command in a testing environment without errors, or that the intercepted command does not include common typographical errors, or that the person is certain that the intercepted command should be executed, or that a mechanism exists to undo the execution of the intercepted command if necessary, or that execution of the intercepted command will not result in a configuration of the managed service known to have errors, or any combination of these.

Another embodiment is a method of mitigating configuration change risk for a managed service in a customer environment. The method includes intercepting a command sent to a management interface for altering operation of a managed service. The method also includes rating, by a risk rating module executing in the customer environment, a risk of error if the intercepted command were to be executed in the customer environment. The method next includes comparing the rated risk of error to a given error threshold. The method then includes, when the rated risk of error is below the given error threshold, forwarding the intercepted command to the management interface to execute the command, thereby altering the operation of the managed service. However, when the rated risk of error is equal to or above the given error threshold, the method includes (1) requesting an authorization code, and (2) only in response to receiving the authorization code, forwarding the intercepted command to the management interface to execute the command, thereby altering the operation of the managed service.

In some embodiments, the management interface comprises a command line interface (CLI) and intercepting the command includes installing a wrapper around the CLI.

In some embodiments, the management interface comprises an application programming interface (API) and intercepting the command includes installing a proxy.

In some embodiments, rating the risk of error includes combining risk factors relating to a respective plurality of sources of risk.

In some embodiments, rating the risk of error includes obtaining the risk factors from a knowledge database that is executing outside the customer environment.

In some embodiments, rating the risk of error includes multiplying risk factors associated with: the customer environment, or the customer, or the intercepted command, or a person who sent the intercepted command, or any managed software or hardware associated with the intercepted command, or the vendor of any such managed software or hardware, or errors logged by the managed service, or any combination of these.

In some embodiments, the risk factors are provided as default values that are increased or decreased on a per-customer basis.

In some embodiments, the given error threshold is provided as a default value that is increased or decreased on a per-customer basis.

In some embodiments, there exists a plurality of risk-mitigating actions, and requesting the authorization code includes requesting an authorization code that indicates completion, by a person who sent the intercepted command to the management interface, of a particular risk-mitigating action from a plurality of such actions.

In some embodiments, the plurality of risk-mitigating actions includes confirming: that an administrative supervisor or peer of the person has approved execution of the intercepted command, or that the person has read a training document relating to the intercepted command, or that the person has executed the intercepted command in a testing environment without errors, or that the intercepted command does not include common typographical errors, or that the person is certain that the intercepted command should be executed, or that a mechanism exists to undo the execution of the intercepted command if necessary, or that execution of the intercepted command will not result in a configuration of the managed service known to have errors, or any combination of these.

A third embodiment is a tangible, computer-readable storage medium, in which is non-transitorily stored computer program code that, when executed by a computing processor, performs the method of the second embodiment or any of its variants.

It is appreciated that the concepts, techniques, and structures disclosed herein may be embodied in other ways, and thus the above summary of embodiments should not be viewed as limiting.

### DESCRIPTION OF THE SEVERAL VIEWS OF THE DRAWINGS

The manner and process of making and using the disclosed embodiments may be appreciated by reference to the drawings, in which:

FIG. 1 schematically shows a prior art system having managed services in a customer environment;

FIG. 2 schematically shows a system having managed services in a customer environment according to an embodiment of the concepts, techniques, and structures disclosed herein;

FIG. 3 schematically shows a system for mitigating configuration change risk for a managed service executing in a customer environment according to an embodiment;

FIG. 4 is a flowchart for a method of mitigating configuration change risk for a managed service executing in a customer environment according to an embodiment;

FIG. 5 schematically shows a typical client-server system in which the disclosed concepts, structures, and techniques may be advantageously embodied; and

FIG. 6 schematically shows relevant physical components of a computer that may be used to embody the concepts, structures, and techniques disclosed herein.

### DETAILED DESCRIPTION OF EMBODIMENTS

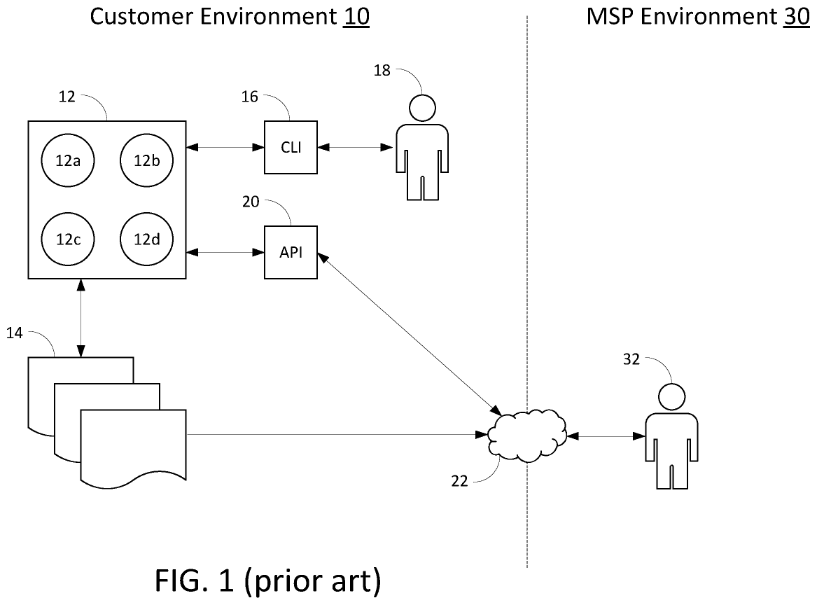

In FIG. 1 is shown a prior art system having managed services in a customer services environment 10, or simply the “customer environment”. Each customer of a managed service provider (MSP) has its own, private customer environment 10 in which to access its managed services, and customers typically do not have access to the environments of other customers. Thus, it should be understood that a single MSP may have multiple customer environments 10, while the MSP itself may have a single MSP environment 30 that it uses for its own purposes, some of which are described below as relevant to disclosed embodiments.

It is known in the prior art for an MSP to utilize, in the customer environment 10, a server 12 on which are executing managed services 12a, 12b, 12c, 12d. The server 12 may be implemented as any computer server (or cluster of servers) known in the art for providing managed services. The server 12 may be physically located at a customer premises or co-located in an off-premises data center. The particular managed services 12a-12d that are hosted on the server 12 may be any managed services that support operations of the customer and may be determined through negotiations between the MSP and the customer (whose description is beyond the scope of this disclosure). The managed services 12a-12d each may produce one or more log files 14 using standard techniques and in standard data formats.

There are two typical management interfaces by which managed services 12a-12d on the server 12 may be accessed. A command line interface (CLI) 16 may provide access to the managed services 12a-12d to users, such as the individual 18, who have authority and credentials to directly log into the server 12. Command line interfaces are well known in the art, and are not further described here. Typically, only highly trusted individuals such as customer or MSP technical staff are given access to the CLI 16 due to the heightened security risk of distributing login credentials. Alternately or in addition, an application programming interface (API) 20 may provide access to the managed services 12a-12d to other users, such as individual 32, who are outside the customer environment 10. The API 20 may take the form of a URL or other identifier that is accessible by the user using a data communication network 22 between the customer environment 10 and the outside environment (in this case, the MSP environment 30).

Customers using the system of FIG. 1 may decide, for a variety of reasons, that the customer environment 10 needs to be reconfigured. To initiate the process, the customer may fill out a service request or report an incident, which may be provided as a web page or other automated form, and indicate what business functions need to be changed or corrected. Employees of the MSP read this form and develop a technical plan to implement the changes. Once the plan is finalized, an MSP engineer uses the CLI 16 or the API 20 to implement it using various known tools and commands. However, the MSP engineer has complete discretion and responsibility to determine whether implementing the plan carries an elevated risk of an incident that might violate a service-level agreement (SLA) between the MSP and the customer, and whether the MSP engineer has sufficient training and immediate approval to execute each of the implementing commands. The prior art system of FIG. 1 thus enables service managing MSP engineers to make mistakes that could be detrimental to the customer, or to the relationship between the customer and the MSP.

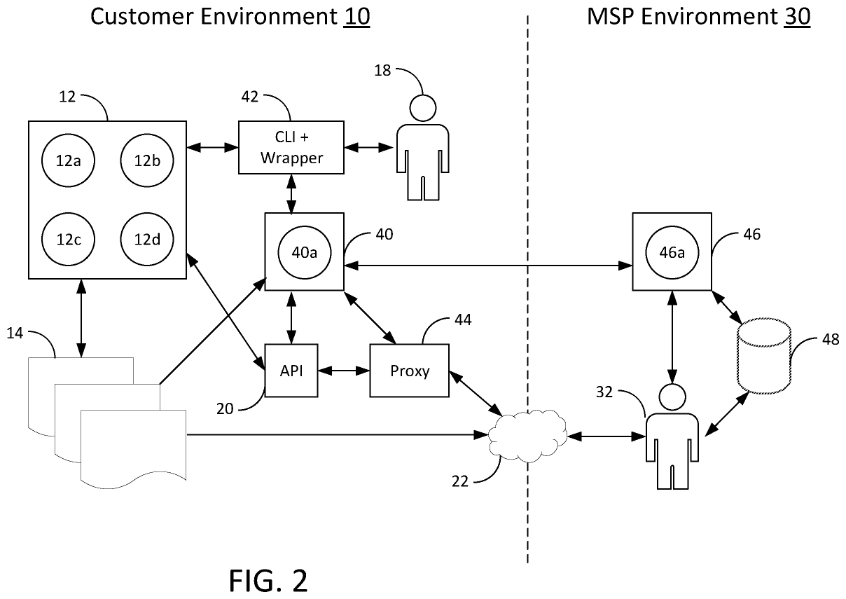

To address these deficiencies in the prior art, in FIG. 2 is schematically shown a system having managed services in a customer environment 10 according to an embodiment of the concepts, techniques, and structures disclosed herein. Embodiments advantageously may be retrofitted onto existing customer environments, and FIG. 2 shows the system of FIG. 1 so modified. In particular, the customer environment 10 is still present in FIG. 2, as are the server 12, the managed services 12a-12d, the log files 14, the individual 18, the API 20, and the data communication network 22. Likewise, the MSP environment 30 is still shown, albeit with modifications according to the embodiment, and the individual 32 is still shown. These items are the same as in FIG. 1 to illustrate how such a retrofit is possible. Nevertheless, it is appreciated that new customer environments may be created in accordance with disclosed embodiments, and thus that the reuse in FIG. 2 of some elements of FIG. 1 should not be viewed as limiting.

One improvement of FIG. 2 over the prior art of FIG. 1 is the addition of a customer mitigation server 40 executing a mitigation service 40a. The customer mitigation server 40 may be implemented as any computer server (or cluster of servers) known in the art. The customer mitigation server 40 may be physically located at a customer premises or co-located in an off-premises data center. While the customer mitigation server 40 is conceptually distinct from the server 12, it is appreciated that these two elements may operate using the same physical computer hardware.

The customer mitigation server 40 and the mitigation service 40a are configurable, and enforce risk mitigation actions undertaken when changing configuration of managed services 12a-12d in the customer environment 10. In operation, configuration commands (e.g. issued by the individual 18 or the individual 32) meant for the managed services 12a-12d are intercepted and rerouted to the customer mitigation server 40, prior to their execution, for analysis and risk mitigation. This rerouting function is accomplished in the case of the CLI 16 by installing a wrapper around the CLI, yielding the CLI+wrapper element 42. Functional wrappers are well known, and a person of ordinary skill in the art should understand how to implement a wrapper (e.g. by renaming executable files, or using dynamically linked object libraries, or other techniques). In the case of the API 20, rerouting is accomplished by installing a proxy 44 between the API 20 and the data communication network 22. Proxies are well known, and a person of ordinary skill in the art should understand how to install a proxy (e.g. by adding a module to a web server that provides the API 20, or another web server executing the proxy 44, or other techniques).

Once the customer mitigation server 40 receives the intercepted command, its mitigation service 40a undertakes a risk evaluation process. Illustrative embodiments evaluate as many different sources of risk as possible, including those relating to: the customer, the customer environment 10, the operation of the managed services 12a-12d (especially as indicated in the log files 14), the MSP and its technical staff, the MSP environment 30, and the particular details of the attempted command. These risks are combined into an overall “risk rating” associated with the intercepted command. If the risk rating indicates that the risk of executing the command falls below a configurable threshold, the command is executed. However, if the risk rating indicates that the risk of executing the command is at or above the threshold, then an enforceable mitigation event occurs in which the individual who issued the command must undertake further manual steps prior to the command being executed. These mitigation actions are themselves configurable according to the determined level of risk.

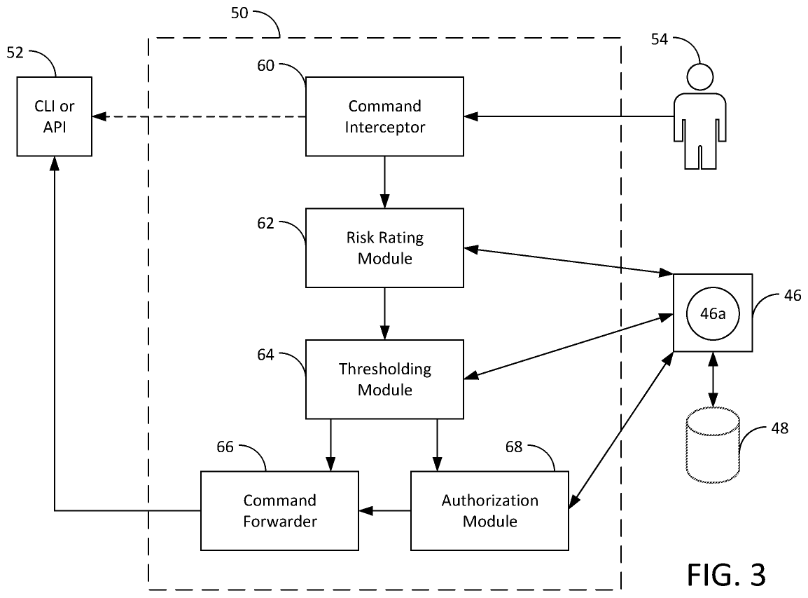

To facilitate all of these processes occurring in the customer mitigation server 40, an MSP mitigation server 46 executing a mitigation service 46a and a knowledge database 48 are provided. The MSP mitigation server 46 may be implemented as any computer server (or cluster of servers) known in the art suitable for executing the mitigation service 46a as described in more detail in connection with FIG. 3. The knowledge database 48 may be implemented using any database known in the art; its operation also is described in more detail in connection with FIG. 3.

The mitigation process 40a and the mitigation process 46a may communicate with each other using any data communication network known in the art, which may or may not be the data communication network 22, according to any convenient data interchange protocols. The mitigation process 46a and the knowledge base 48 themselves may be accessed and configured by an appropriately authorized MSP employee or agent (i.e. the individual 32), as indicated. Alternately or in addition, the mitigation process 46a may gather information and update the knowledge base 48 as described further below.

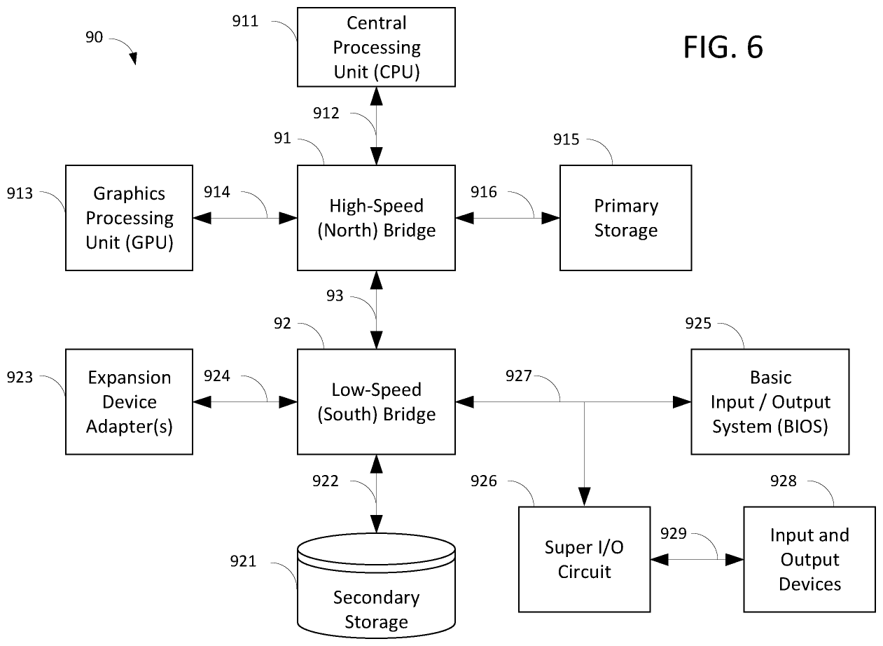

In FIG. 3 is schematically shown a system 50 for mitigating configuration change risk for a managed service executing in a customer environment according to an embodiment. The customer environment may be customer environment 10, and the system 50 may implement the customer mitigation server 40, or the mitigation service 40a, or both. The system 50 intercepts configuration commands sent to a management interface 52 by an individual 54 for altering operation of a managed service. As indicated in FIG. 3, the management interface 52 may be the CLI 16 or the API 20, but it is appreciated that other management interfaces may be used. The system 50 may be implemented using any means known in the art for performing the functions described below. Thus, the system 50 may be implemented in computer hardware, software, or a combination thereof, and in particular may be implemented in whole or in part by the computer shown in FIG. 6 and described below.

The system 50 includes a command interceptor 60. The command interceptor 60 is responsible for intercepting the command sent to the management interface 52. Illustratively, if the management interface 52 comprises a CLI, then the command interceptor 60 may be a wrapper around the CLI. Alternately, if the management interface 52 comprises an API, then the command interceptor 60 may be a proxy. A person having ordinary skill in the art may know other ways to create a command interceptor 60 according to the management interface 52. The command interceptor 60 prevents the command from reaching the management interface 52, and FIG. 3 indicates this averted data path by a dashed arrow.

The system 50 also includes a risk rating module 62. The risk rating module 62 rates a risk of error if the intercepted command were to be executed in the customer environment. The risk rating module computes the risk rating by combining risk factors relating to many sources of risk, and different factors can be associated with operations and personnel. In illustrative embodiments, a risk rating is a number between zero and one, with zero representing “always results in failure” and one representing “no risk of failure”. An overall risk rating can be computed as a multiplicative product of individual ratings that each pertain to a particular risk. Thus, a smaller numerical value for the risk rating corresponds to greater risk, while conversely a larger numerical value for the risk rating corresponds to lesser risk. In other words, the risk rating may be viewed roughly as a probability that executing the intercepted command will complete without unacceptable errors.

As may be appreciated, each component risk rating in the multiplicative product represents a probability of success had by commands relating to the relevant risk factor. Thus, the risk of an error occurring due to that factor equals the risk rating, subtracted from the value one (1.0). For example, a risk rating of 0.9 corresponds to a 10% risk of an unacceptable error occurring when the intercepting command is executed.

The identity of the customer may be used as a risk factor. Some customers may have stricter performance criteria according to an SLA than others, or may have larger numbers of currently-open trouble tickets than others. Each condition could increase the chance of a failed configuration change, and thus lower the corresponding risk rating toward zero.

The configuration of the customer environment may be used as a risk factor. Some customers may have complex environment configurations, or may use older hardware or software that is inflexible and difficult to modify.

The identities of the MSP personnel issuing the commands may be used as a risk factor. Different personnel have different levels of experience in different technologies, and what might be a routine task for one MSP engineer may be difficult for another. Also, the more users that are issuing configuration change commands to implement a single change plan, the more likely that an error will occur due to a lack of clear and complete communication between the team members, or commands that are issued out of the correct sequence. And the risk rating might be further numerically lowered based on a lack of experience that a particular MSP engineer has with the particular customer.

The particular details of the intercepted command may be used as a risk factor. Illustratively, consider a command sent to the customer environment through an API to expand a storage array. This command may be parsed by the risk rating module as having an action of “expand”, an object of “LUN”, and an adverb of “online”. The combination of these three items may have an associated risk rating, or each item may have its own risk rating and the ratings are multiplied to yield a rating for the command risk factor.

Alternately or in addition, any individual item or model of managed software or hardware may have its own risk rating, as might the vendor of the managed software or hardware. Thus, a risk rating might be assigned to all configuration changes involving hardware from a particular vendor due to recently occurring errors on that vendor's hardware during high volume operations (as illustratively indicated by entries in log files for various managed services).

It is also contemplated that global risk ratings may be adjusted on a per-customer basis. For example, even if certain hardware or software deployed in the customer environment is difficult to configure in general, a particular customer may have additional failsafe mechanisms in place to mitigate the effects of incorrect configurations, thereby reducing the risk in implementing change.

In illustrative embodiments, the number of risk factors may be vast, and their sources and associated risk ratings may require continual updating. Therefore, the risk rating module 62 may be operated to obtain as much customer-specific information from the customer environment as possible on a continual basis, including from any log files generated by the managed services. The risk rating module 62 also may be configured to obtain information that is not customer-specific (e.g. global default risk ratings) from the knowledge database 48. The knowledge database 48 may execute outside the customer environment, i.e. in the MSP environment. The MSP mitigation server 46 and mitigation service 46a are provided to facilitate this data retrieval function of the system 50.

The knowledge database 48 stores accumulated intelligence regarding risk factors. This intelligence may derive from a wide range of sources. Illustratively, the knowledge data may be obtained from configuration change requests or “tickets” filled out by customers. These data may be analyzed and summarized in overall statistics, and also may be analyzed on a customer-by-customer basis. The knowledge data also may be obtained from customer mitigation services executing in the various customer environments managed by the MSP. In particular these customer mitigation services may continually collect data about the customer environment that is relevant to risk analysis, and forward these data to the knowledge database 48 via the mitigation service 46a. The knowledge data may be further obtained from MSP personnel, individual customers, and product vendors in the form of, for example: customer relationship or preference data; corporate directives; product specifications; service-level agreement guarantees; MSP engineer knowledge, skills, and experience data; and other such data. It is appreciated that other sources of knowledge data pertaining to risk assessment may be used, and that a person having ordinary skill in the art will understand how to integrate these other sources of data into the knowledge database 48.

The system 50 also includes a thresholding module 64. The thresholding module 64 compares the rated risk of error to a given error threshold. As with the risk rating, the given error threshold may be provided as a default value that is increased or decreased on a per-customer basis, depending on the terms of the SLA, or the risk tolerance of the client, or other factors.

In some embodiments, the thresholding module 64 compares the risk rating to multiple thresholds, with lower thresholds corresponding to greater chances of unacceptable errors occurring, and thus greater care that must be taken when executing the intercepted command. These various thresholds can be used to assign particular mitigation actions to risk ratings. For example: a risk rating greater than 0.8 might indicate that no mitigation is required; a risk rating between 0.7 and 0.8 might indicate that the MSP engineer is advised to read documentation; a risk rating between 0.65 and 0.7 might require the MSP engineer to read documentation; a risk rating between 0.6 and 0.65 might require the MSP engineer to get peer approval to execute the command; a risk rating between 0.55 and 0.6 might require the MSP engineer to get supervisor approval; and a risk rating below 0.55 might indicate that the risk is too great and the command will not be executed. Completion of these mitigating actions is enforceable using authorization codes, as described in connection with the authorization module 68.

Configuration of the various thresholds may be stored in the system 50 itself, or the thresholding module 64 may communicate with the mitigation service 46a to determine its thresholds and corresponding mitigation actions. In the latter case, updates to the thresholds, whether at the direction of the customer or the MSP, can be communicated to the thresholding module 64 as they occur, advantageously providing dynamic reconfigurability of the mitigation system 50 itself.

The system 50 also includes a command forwarder 66. The command forwarder 66 is activated when the risk of error is below a given error threshold; that is, the thresholding module 64 determines that the risk of executing the command is acceptable because the risk rating is high enough. In this case, the command forwarder 66 forwards the intercepted command to the management interface 52 to execute the command, thereby altering the operation of the managed service.

The system 50 also includes an authorization module 68. The authorization module 68 is activated when the risk of error is equal to or above the given error threshold; that is, the thresholding module 64 determines that the risk of executing the command is not acceptable because the risk rating is too low. In this case, the authorization module 68 undertakes a two-step process to enforce mitigation before execution of the intercepted command is authorized.

First, the authorization module 68 requests the individual 54 to enter an authorization code. In case multiple mitigation actions are possible based on the value of the risk rating, the individual 54 must enter an authorization code associated with the correct mitigation action. That is, the authorization module is configured for requesting an authorization code that indicates completion, by the individual 54, of a particular risk-mitigating action from several such actions. The association between authorization code and mitigation action can be arranged between the authorization module 68 and the mitigation service 46a using any suitable data interchange protocol for sharing secret information, such as a key exchange algorithm or other cryptographic means. Such means are used to prevent the individual 54 from discovering the authorization code without having taken the associated mitigation action.

Second, and only in response to receiving the correct authorization code from the individual 54, the authorization module 68 forwards the intercepted command to the management interface to execute the command, thereby altering the operation of the managed service. The authorization module 58 may provide the intercepted command to the command forwarder 66 for this purpose. Enforceability of the mitigation actions is guaranteed by the further requirement that the individual 54 must perform the appropriate action in order to receive the authorization code from the mitigation service 46a. For example, suppose the mitigation action is to seek supervisor approval to execute the intercepted command. Before the individual 54 may obtain the authorization code from the mitigation service 46a, the relevant supervisor must access the mitigation service 46a and indicate that the code should be released. Presumably, the supervisor will do so only after having reviewed and approved execution of the command.

Other mitigation actions are enforced similarly. It is appreciated that risk-mitigating actions may be very diverse. Illustratively, one such action is that an administrative supervisor or peer of the person has approved execution of the intercepted command. Another such action is that the person has read a training document relating to the intercepted command. Yet another such action is that the person has executed the intercepted command in a testing environment without errors. Still another such action is confirming that the intercepted command does not include common typographical errors. A further such action is that the person is certain that the intercepted command should be executed. Another such action is to confirm that a mechanism exists to undo the execution of the intercepted command if necessary. And another such action is to confirm that execution of the intercepted command will not result in a configuration of the managed service known to have errors. A person having ordinary skill in the art may know of or develop other risk-mitigating actions in accordance with the concepts, techniques, and structures disclosed herein.

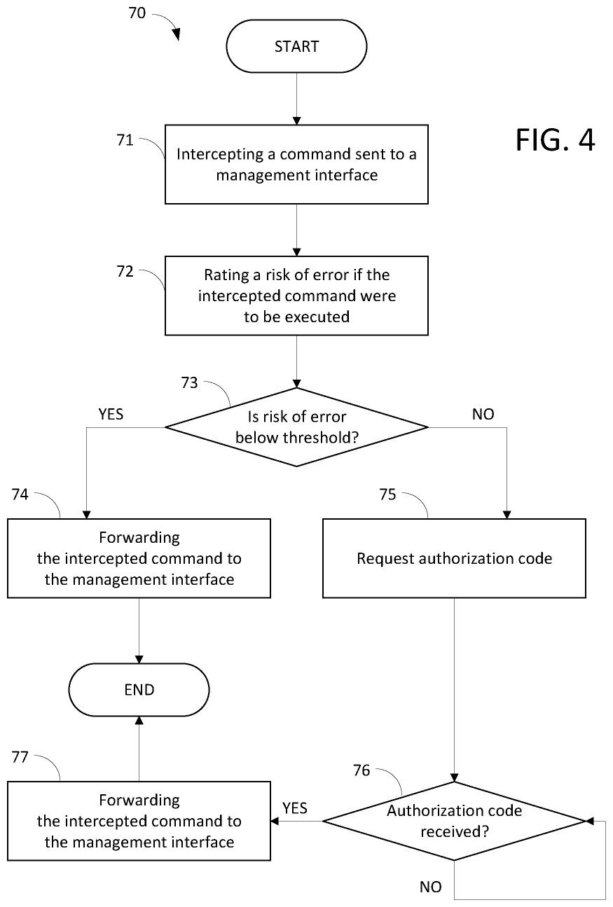

In FIG. 4 is shown a flowchart for a method 70 of mitigating configuration change risk for a managed service executing in a customer environment according to an embodiment. The customer environment may be customer environment 10, and the method 70 may be performed illustratively by mitigation service 40a, or by the system 50, or by another machine or manufacture configured for that purpose.

The method 70 begins with a process 71 for intercepting a command sent to a management interface for altering operation of the managed service. The process 71 may be performed by the command interceptor 60. Illustratively, if the management interface comprises a CLI, then intercepting the command may include installing a wrapper around the CLI. Alternately, if the management interface comprises an API, then intercepting the command may include installing a proxy. A person having ordinary skill in the art may know other ways to intercept commands according to the management interface.

The method 70 continues with a process 72 for rating, by a risk rating module executing in the customer environment, a risk of error if the intercepted command were to be executed in the customer environment. The process 72 may be performed by the risk rating module 62. Thus, in some embodiments rating the risk of error includes combining risk factors relating to a respective plurality of sources of risk. The risk factors may be obtained from a knowledge database that is executing outside the customer environment, e.g. in the MSP environment. The risk of error may be computed by multiplying risk factors associated with: the customer environment, or the customer, or the intercepted command, or a person who sent the intercepted command, or any managed software or hardware associated with the intercepted command, or the vendor of any such managed software or hardware, or errors logged by the managed service, or any combination of these. And in some embodiments, the risk factors are provided as default values that are increased or decreased on a per-customer basis.

The method 70 next includes a decision process 73 for comparing the rated risk of error to a given error threshold. The process 73 may be performed by the thresholding module 64. Thus, in some embodiments the given error threshold is provided as a default value that is increased or decreased on a per-customer basis.

When the rated risk of error is below the given error threshold, the method 70 next performs a process 74 for forwarding the intercepted command to the management interface to execute the command, thereby altering the operation of the managed service. The process 74 may be performed by the command forwarder 66.

However, when the rated risk of error is equal to or above the given error threshold, the method 70 next performs a process 75 for requesting an authorization code. The method 70 then waits in a process 76 to receive the authorization code. Only in response to receiving the authorization code, does the method 70 advance to a process 77 for forwarding the intercepted command to the management interface to execute the command, thereby altering the operation of the managed service.

The process 77 may be performed in substantially the same way as the process 74, and the processes 75, 76, and 77 illustratively may be performed by the authorization module 68. Thus, in some embodiments requesting the authorization code includes requesting an authorization code that indicates completion, by a person who sent the intercepted command to the management interface, of a risk-mitigating action from a plurality of such actions. And those risk-mitigating actions may include confirming: that an administrative supervisor or peer of the person has approved execution of the intercepted command, or that the person has read a training document relating to the intercepted command, or that the person has executed the intercepted command in a testing environment without errors, or that the intercepted command does not include common typographical errors, or that the person is certain that the intercepted command should be executed, or that a mechanism exists to undo the execution of the intercepted command if necessary, or that execution of the intercepted command will not result in a configuration of the managed service known to have errors, or any combination of these.

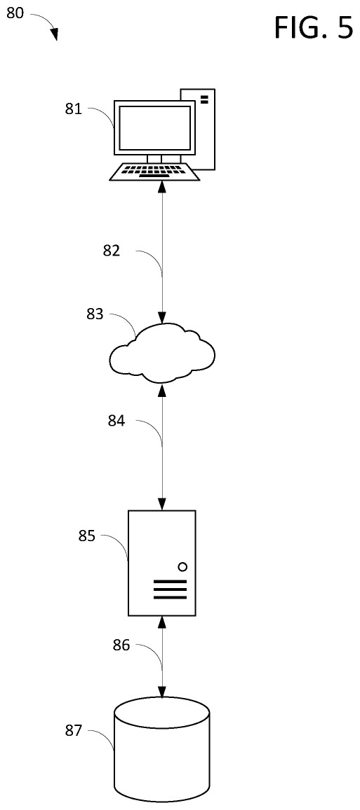

FIG. 5 schematically shows a typical client-server system in which the disclosed concepts, structures, and techniques may be advantageously embodied. In accordance with client-server principles, the system 80 includes at least one client device coupled for bidirectional data communication with at least one server device using a data network. Generally, the client requests, via the data network, that the server perform a computation or other function, and the server responsively fulfills the request, optionally returning a result or status indicator to the client via the data network. In particular, the system 80 may be used by the individual 32 to access the server 12, or by the system 50 to access the mitigation server 46.

Thus, the system 80 includes a client device 81. The client device 81 is illustrated as a desktop computer, but may be any electronic device known in the art, including without limitation a laptop computer, tablet computer, smartphone, embedded system, or any other device capable of transmitting and receiving data, and requesting that another electronic device perform a computation.

The client device 81 is coupled, via a data link 82, to a data network 83. The data link 82 is any combination of hardware or software suited for communicating data between the client device 81 and other electronic devices via the data network 83. The data link 82 may be, for example, a wired Ethernet link based on the Institute of Electrical and Electronics Engineers (“IEEE”) 802.3 family of standards, a wireless radio link based on the IEEE 802.11 family of standards (“Wi-Fi”), or any other data connection.

The data network 83 is any combination of hardware or software suited for communicating data between electronic devices via data links. The data network 83 may be, for example, a local area network (“LAN”), a wide area network (“WAN”), a metropolitan area network (“MAN”), a virtual private network (“VPN”), the Internet, or any other type of data network.

It is appreciated that a data network 83 operates to mediate data communication between multiple electronic devices. Thus, the depiction of only a single client device 81 in FIG. 5 is merely illustrative, and a typical system 80 may have any number of client devices coupled for data communication using corresponding data links to the data network 83. It is also appreciated that the data network 83 may be operated by any number of autonomous entities, and thus may be a conglomeration of smaller networks that exchange data according to standardized protocols and data formats, including without limitation the Internet Protocol (“IP”) specified by Internet Standard STD 5, the User Datagram Protocol (“UDP”) specified by Internet Standard STD 6, and the Transmission Control Protocol (“TCP”) specified by Internet Standard STD 7, among others.

The data network 83 allows the client device 81 to communicate with a server device 85, which is coupled to the data network 83 using a data link 84. The data link 84 is any combination of hardware or software suited for communicating data between the server device 85 and other electronic devices via the data network 83. The server device 85 may be any electronic device known in the art that can transmit and receive data and can perform a computation on behalf of another electronic device.

Again, the data network 83 operates to mediate data communication between multiple electronic devices. Thus, the depiction of only a single server device 85 in FIG. 5 is merely illustrative, and a typical system 80 may have any number of server devices coupled for data communication using corresponding data links to the data network 83. In order to provide simultaneous service to large numbers of client devices, a particular computation (or type of computation, such as rendering a web page) may be allocated to one of multiple server devices using a load balancer or other device. It is further appreciated that the server device 85, along with additional server devices if required, may provide well-defined operations known as “services” according to a service-oriented architecture (“SOA”), as those terms are known in the art.

It is appreciated in accordance with client-server principles that the designation of device 81 as the “client device” and device 85 as the “server device” is arbitrary, as most electronic devices that are capable of transmitting and receiving data can perform computations on behalf of other electronic devices upon receipt of data, so requesting, according to a mutually agreed protocol. Thus, the designation of “client device” and “server device” is made herein with regard to an intended mode of operation of the system 80, namely that the client device 81 is the device requesting that a particular computation be performed on behalf of a user thereof, and that the server device 85 operates a “service” to perform the computation and communicate the results to the client device 81. A typical protocol for such interaction is the Hypertext Transfer Protocol (“HTTP” or “HTTP/1.1”) specified as a proposed Internet Standard by Requests for Comment (“RFC”) 7230 through 7235, which is used to implement the World Wide Web.

FIG. 5 shows the server device 85 coupled, via a storage link 86, to a data storage device 87. The data storage device 87 may be a database, file system, volatile or non-volatile memory, network attached storage (“NAS”), storage area network (“SAN”), or any other hardware or software that is capable of storing data used by a server device 85 or a service executing thereon. The storage link 86 may be any hardware or software capable of communicating data between the server device 85 and the data storage device 87. It is appreciated that, where more than one server device 85 is present, multiple server devices may communicate with the same data storage device 87 to provide data sharing between the server devices.

It is appreciated that a requested computation may be done in several parts, thereby requiring the system 80 to retain an intermediate computational state between requests. If the services provided by the server device 85 do not store any such state (for example, to simplify their design), then the client device 81 must supply all state with each request. This type of communication may be provided using the representational state transfer (“REST”) client-server architecture. In addition to being a stateless client-server architecture, REST systems permit responses to requests with identical inputs to be cached to improve response time; permit layering of services, thereby multiplying available functionality; permit services to require clients to perform some computation locally to improve performance; and provide a uniform interface for all client devices.

FIG. 6 schematically shows relevant physical components of a computer 90 that may be used to embody the concepts, structures, and techniques disclosed herein. In particular, the computer 90 may be used to implement, in whole or in part: the server 12, or the CLI 16, or the API 20, or the customer mitigation server 40, or the mitigation service 40a, or the wrapper portion of element 42, or the proxy 44, or the MSP mitigation server 46, or the mitigation service 46a, or the database 48, or the system 50, or the command interceptor 60, or the risk rating module 62, or the thresholding module 64, or the command forwarder 66, or the authorization module 68. Generally, the computer 90 has many functional components that communicate data with each other using data buses. The functional components of FIG. 6 are physically arranged based on the speed at which each must operate, and the technology used to communicate data using buses at the necessary speeds to permit such operation.

Thus, the computer 90 is arranged as high-speed components and buses 911 to 916 and low-speed components and buses 921 to 929. The high-speed components and buses 911 to 916 are coupled for data communication using a high-speed bridge 91, also called a “northbridge,” while the low-speed components and buses 921 to 929 are coupled using a low-speed bridge 92, also called a “southbridge.”

The computer 90 includes a central processing unit (“CPU”) 911 coupled to the high-speed bridge 91 via a bus 912. The CPU 911 is electronic circuitry that carries out the instructions of a computer program. As is known in the art, the CPU 911 may be implemented as a microprocessor; that is, as an integrated circuit (“IC”; also called a “chip” or “microchip”). In some embodiments, the CPU 911 may be implemented as a microcontroller for embedded applications, or according to other embodiments known in the art.

The bus 912 may be implemented using any technology known in the art for interconnection of CPUs (or more particularly, of microprocessors). For example, the bus 912 may be implemented using the HyperTransport architecture developed initially by AMD, the Intel QuickPath Interconnect (“QPI”), or a similar technology. In some embodiments, the functions of the high-speed bridge 91 may be implemented in whole or in part by the CPU 911, obviating the need for the bus 912.

The computer 90 includes one or more graphics processing units (GPUs) 913 coupled to the high-speed bridge 91 via a graphics bus 914. Each GPU 913 is designed to process commands from the CPU 911 into image data for display on a display screen (not shown). In some embodiments, the CPU 911 performs graphics processing directly, obviating the need for a separate GPU 913 and graphics bus 914. In other embodiments, a GPU 913 is physically embodied as an integrated circuit separate from the CPU 911 and may be physically detachable from the computer 90 if embodied on an expansion card, such as a video card. The GPU 913 may store image data (or other data, if the GPU 913 is used as an auxiliary computing processor) in a graphics buffer.

The graphics bus 914 may be implemented using any technology known in the art for data communication between a CPU and a GPU. For example, the graphics bus 914 may be implemented using the Peripheral Component Interconnect Express (“PCI Express” or “PCIe”) standard, or a similar technology.

The computer 90 includes a primary storage 915 coupled to the high-speed bridge 91 via a memory bus 916. The primary storage 915, which may be called “main memory” or simply “memory” herein, includes computer program instructions, data, or both, for use by the CPU 911. The primary storage 915 may include random-access memory (“RAM”). RANI is “volatile” if its data are lost when power is removed, and “non-volatile” if its data are retained without applied power. Typically, volatile RAM is used when the computer 90 is “awake” and executing a program, and when the computer 90 is temporarily “asleep”, while non-volatile RAM (“NVRAM”) is used when the computer 90 is “hibernating”; however, embodiments may vary. Volatile RAM may be, for example, dynamic (“DRAM”), synchronous (“SDRAM”), and double-data rate (“DDR SDRAM”). Non-volatile RAM may be, for example, solid-state flash memory. RAM may be physically provided as one or more dual in-line memory modules (“DIMMs”), or other, similar technology known in the art.

The memory bus 916 may be implemented using any technology known in the art for data communication between a CPU and a primary storage. The memory bus 916 may comprise an address bus for electrically indicating a storage address, and a data bus for transmitting program instructions and data to, and receiving them from, the primary storage 915. For example, if data are stored and retrieved 64 bits (eight bytes) at a time, then the data bus has a width of 64 bits. Continuing this example, if the address bus has a width of 32 bits, then 2³² memory addresses are accessible, so the computer 90 may use up to 8*2³²=32 gigabytes (GB) of primary storage 915. In this example, the memory bus 916 will have a total width of 64+32=96 bits. The computer 90 also may include a memory controller circuit (not shown) that converts electrical signals received from the memory bus 916 to electrical signals expected by physical pins in the primary storage 915, and vice versa.

Computer memory may be hierarchically organized based on a tradeoff between memory response time and memory size, so depictions and references herein to types of memory as being in certain physical locations are for illustration only. Thus, some embodiments (e.g. embedded systems) provide the CPU 911, the graphics processing units 913, the primary storage 915, and the high-speed bridge 91, or any combination thereof, as a single integrated circuit. In such embodiments, buses 912, 914, 916 may form part of the same integrated circuit and need not be physically separate. Other designs for the computer 90 may embody the functions of the CPU 911, graphics processing units 913, and the primary storage 915 in different configurations, obviating the need for one or more of the buses 912, 914, 916.

The depiction of the high-speed bridge 91 coupled to the CPU 911, GPU 913, and primary storage 915 is merely exemplary, as other components may be coupled for communication with the high-speed bridge 91. For example, a network interface controller (“NIC” or “network adapter”) may be coupled to the high-speed bridge 91, for transmitting and receiving data using a data channel. The NIC may store data to be transmitted to, and received from, the data channel in a network data buffer.

The high-speed bridge 91 is coupled for data communication with the low-speed bridge 92 using an internal data bus 93. Control circuitry (not shown) may be required for transmitting and receiving data at different speeds. The internal data bus 93 may be implemented using the Intel Direct Media Interface (“DMI”) or a similar technology.

The computer 90 includes a secondary storage 921 coupled to the low-speed bridge 92 via a storage bus 922. The secondary storage 921, which may be called “auxiliary memory”, “auxiliary storage”, or “external memory” herein, stores program instructions and data for access at relatively low speeds and over relatively long durations. Since such durations may include removal of power from the computer 90, the secondary storage 921 may include non-volatile memory (which may or may not be randomly accessible).

Non-volatile memory may comprise solid-state memory having no moving parts, for example a flash drive or solid-state drive. Alternately, non-volatile memory may comprise a moving disc or tape for storing data and an apparatus for reading (and possibly writing) the data. Data may be stored (and possibly rewritten) optically, for example on a compact disc (“CD”), digital video disc (“DVD”), or Blu-ray disc (“BD”), or magnetically, for example on a disc in a hard disk drive (“HDD”) or a floppy disk, or on a digital audio tape (“DAT”). Non-volatile memory may be, for example, read-only (“ROM”), write-once read-many (“WORM”), programmable (“PROM”), erasable (“EPROM”), or electrically erasable (“EEPROM”).

The storage bus 922 may be implemented using any technology known in the art for data communication between a CPU and a secondary storage and may include a host adaptor (not shown) for adapting electrical signals from the low-speed bridge 92 to a format expected by physical pins on the secondary storage 921, and vice versa. For example, the storage bus 922 may use a Universal Serial Bus (“USB”) standard; a Serial AT Attachment (“SATA”) standard; a Parallel AT Attachment (“PATA”) standard such as Integrated Drive Electronics (“IDE”), Enhanced IDE (“EIDE”), ATA Packet Interface (“ATAPI”), or Ultra ATA; a Small Computer System Interface (“SCSI”) standard; or a similar technology.

The computer 90 also includes one or more expansion device adapters 923 coupled to the low-speed bridge 92 via a respective one or more expansion buses 924. Each expansion device adapter 923 permits the computer 90 to communicate with expansion devices (not shown) that provide additional functionality. Such additional functionality may be provided on a separate, removable expansion card, for example an additional graphics card, network card, host adaptor, or specialized processing card.

Each expansion bus 924 may be implemented using any technology known in the art for data communication between a CPU and an expansion device adapter. For example, the expansion bus 924 may transmit and receive electrical signals using a Peripheral Component Interconnect (“PCI”) standard, a data networking standard such as an Ethernet standard, or a similar technology.

The computer 90 includes a basic input/output system (“BIOS”) 925 and a Super I/O circuit 926 coupled to the low-speed bridge 92 via a bus 927. The BIOS 925 is a non-volatile memory used to initialize the hardware of the computer 90 during the power-on process. The Super I/O circuit 926 is an integrated circuit that combines input and output (“I/O”) interfaces for low-speed input and output devices 928, such as a serial mouse and a keyboard. In some embodiments, BIOS functionality is incorporated in the Super I/O circuit 926 directly, obviating the need for a separate BIOS 925.

The bus 927 may be implemented using any technology known in the art for data communication between a CPU, a BIOS (if present), and a Super I/O circuit. For example, the bus 927 may be implemented using a Low Pin Count (“LPC”) bus, an Industry Standard Architecture (“ISA”) bus, or similar technology. The Super I/O circuit 926 is coupled to the I/O devices 928 via one or more buses 929. The buses 929 may be serial buses, parallel buses, other buses known in the art, or a combination of these, depending on the type of I/O devices 928 coupled to the computer 90.

The concepts, techniques, and structures described herein may be implemented in any of a variety of different forms. For example, features of embodiments may take various forms of communication devices, both wired and wireless; television sets; set top boxes; audio/video devices; laptop, palmtop, desktop, and tablet computers with or without wireless capability; personal digital assistants (PDAs); telephones; pagers; satellite communicators; cameras having communication capability; network interface cards (NICs) and other network interface structures; base stations; access points; integrated circuits; as instructions and/or data structures stored on machine readable media; and/or in other formats. Examples of different types of machine readable media that may be used include floppy diskettes, hard disks, optical disks, compact disc read only memories (CD-ROMs), digital video disks (DVDs), Blu-ray disks, magneto-optical disks, read only memories (ROMs), random access memories (RAMs), erasable programmable ROMs (EPROMs), electrically erasable programmable ROMs (EEPROMs), magnetic or optical cards, flash memory, and/or other types of media suitable for storing electronic instructions or data.

In the foregoing detailed description, various features of embodiments are grouped together in one or more individual embodiments for the purpose of streamlining the disclosure. This method of disclosure is not to be interpreted as reflecting an intention that the claims require more features than are expressly recited therein. Rather, inventive aspects may lie in less than all features of each disclosed embodiment.

Having described implementations which serve to illustrate various concepts, structures, and techniques which are the subject of this disclosure, it will now become apparent to those of ordinary skill in the art that other implementations incorporating these concepts, structures, and techniques may be used. Accordingly, it is submitted that that scope of the patent should not be limited to the described implementations but rather should be limited only by the spirit and scope of the following claims.

What is claimed is:

1. A system for mitigating configuration change risk for a managed service in a customer environment, the system comprising:
a command interceptor configured for intercepting a command sent to a management interface for altering operation of the managed service;
a risk rating module configured for rating a risk of error if the intercepted command were to be executed in the customer environment;
a thresholding module configured for comparing the rated risk of error to a given error threshold;
a command forwarder configured for, when the rated risk of error is below the given error threshold, forwarding the intercepted command to the management interface to execute the command, thereby altering the operation of the managed service; and
an authorization module configured for, when the rated risk of error is equal to or above the given error threshold, (1) requesting an authorization code, and (2) only in response to receiving the authorization code, forwarding the intercepted command to the management interface to execute the command, thereby altering the operation of the managed service.

2. The system according to claim 1, wherein the management interface comprises a command line interface (CLI) and the command interceptor includes a wrapper around the CLI.

3. The system according to claim 1, wherein the management interface comprises an application programming interface (API) and the command interceptor includes a proxy.

4. The system according to claim 1, wherein the risk rating module is configured for combining risk factors relating to a respective plurality of sources of risk.

5. The system according to claim 4, further comprising a knowledge database that is executing outside the customer environment, wherein the risk rating module is configured for obtaining the risk factors from the knowledge database.

6. The system according to claim 4, wherein the risk rating module is configured for multiplying risk factors associated with: the customer environment, or the customer, or the intercepted command, or a person who sent the intercepted command, or any managed software or hardware associated with the intercepted command, or the vendor of any such managed software or hardware, or errors logged by the managed service, or any combination of these.

7. The system according to claim 6, wherein the risk factors are provided as default values that are increased or decreased on a per-customer basis.

8. The system according to claim 1, wherein the given error threshold is provided as a default value that is increased or decreased on a per-customer basis.

9. The system according to claim 1, wherein the authorization module is configured for requesting an authorization code that indicates completion, by a person who sent the intercepted command to the management interface of a particular risk-mitigating action from a plurality of such actions.

10. The system according to claim 9, wherein the plurality of risk-mitigating actions includes confirming: that an administrative supervisor or peer of the person has approved execution of the intercepted command, or that the person has read a training document relating to the intercepted command, or that the person has executed the intercepted command in a testing environment without errors, or that the intercepted command does not include common typographical errors, or that the person is certain that the intercepted command should be executed, or that a mechanism exists to undo the execution of the intercepted command if necessary, or that execution of the intercepted command will not result in a configuration of the managed service known to have errors, or any combination of these.

11. A method of mitigating configuration change risk for a managed service in a customer environment, the method comprising:
intercepting a command sent to a management interface for altering operation of the managed service;
rating, by a risk rating module executing in the customer environment, a risk of error if the intercepted command were to be executed in the customer environment;
comparing the rated risk of error to a given error threshold;
when the rated risk of error is below the given error threshold, forwarding the intercepted command to the management interface to execute the command, thereby altering the operation of the managed service; and
when the rated risk of error is equal to or above the given error threshold, (1) requesting an authorization code, and (2) only in response to receiving the authorization code, forwarding the intercepted command to the management interface to execute the command, thereby altering the operation of the managed service.

12. The method according to claim 11, wherein the management interface comprises a command line interface (CLI) and intercepting the command includes installing a wrapper around the CLI.

13. The method according to claim 11, wherein the management interface comprises an application programming interface (API) and intercepting the command includes installing a proxy.

14. The method according to claim 11, wherein rating the risk of error includes combining risk factors relating to a respective plurality of sources of risk.

15. The method according to claim 14, wherein rating the risk of error includes obtaining the risk factors from a knowledge database that is executing outside the customer environment.

16. The method according to claim 14, wherein rating the risk of error includes multiplying risk factors associated with: the customer environment, or the customer, or the intercepted command, or a person who sent the intercepted command, or any managed software or hardware associated with the intercepted command, or the vendor of any such managed software or hardware, or errors logged by the managed service, or any combination of these.

17. The method according to claim 16, wherein the risk factors are provided as default values that are increased or decreased on a per-customer basis.

18. The method according to claim 11, wherein the given error threshold is provided as a default value that is increased or decreased on a per-customer basis.

19. The method according to claim 11, wherein requesting the authorization code includes requesting an authorization code that indicates completion, by a person who sent the intercepted command to the management interface of a particular risk-mitigating action from a plurality of such actions.

20. The method according to claim 19, wherein the plurality of risk-mitigating actions includes confirming: that an administrative supervisor or peer of the person has approved execution of the intercepted command, or that the person has read a training document relating to the intercepted command, or that the person has executed the intercepted command in a testing environment without errors, or that the intercepted command does not include common typographical errors, or that the person is certain that the intercepted command should be executed, or that a mechanism exists to undo the execution of the intercepted command if necessary, or that execution of the intercepted command will not result in a configuration of the managed service known to have errors, or any combination of these.
